(19) United States
(12) Patent Application Publication
(10) Pub. No.: US 2011/0164619 A1
(43) Pub. Date: Jul. 7, 2011

(54) METHOD AND SYSTEM FOR SUPPORTING EMERGENCY SERVICE AND PACKET CONTROL FUNCTION ENTITY

(75) Inventors: Wei Wang, Shenzhen (CN); Xiaowu Zhao, Shenzhen (CN)

(73) Assignee: ZTE CORPORATION, Shenzhen, Guangdong Province (CN)

(21) Appl. No.: 12/995,115

(22) PCT Filed: Mar. 6, 2009
(86) PCT No.: PCT/CN2009/070677

§ 371 Date: Nov. 29, 2010

(30) Foreign Application Priority Data
Apr. 1, 2008 (CN) 200810089142.4

(51) Int. Cl. H04L 12/56

(52) U.S. Cl. 370/392

(57) ABSTRACT

A method and system for supporting emergency service over a High Rate Packet Data (HRPD) Access Network (AN) and a Packet Control Function (PCF) entity. The method comprises the following steps: an AN function entity sends information indicating whether a user is using an emergent service to a PCF entity (S302); the PCF entity forwards the information indicating whether the user is utilizing an emergency service to a PDSN(S304). By the present invention, the problem that emergency services can not recognized by the PCF and the PDSN in current HRPD AN may be solved, thus the support of emergency services by HRPD AN can be realized.

### FIELD OF THE INVENTION

The present invention relates to the communication field, in particular to a method and system for supporting emergency service over a High Rate Packet Data Access network and a packet control function entity.

### BACKGROUND OF THE INVENTION

Emergency services generally comprise three basic services: bandit alarm, fire alarm and medical emergency, and in addition, coast rescue, early-warning of bad weather, mine rescue, etc. may also be provided, which can be used by a user without subscription. When an emergency occurs, a user may log-in the network by dialing an emergency number to report or feedback the happened emergency, so as to ensure that the safety of individual and public property can be guaranteed effectively and timely.

The emergency service is a priority service, and usually it is a priority service with the highest priority. The priority service here means defining different priorities for services using priority level values. The service having a higher priority level has priority to obtain a network resource over that having a lower priority level, for example, wireless resource, wired resource, etc., thereby being preferentially scheduled by the network. For different priority level values, the network may also define different processes, which represent the difference of the priority levels. Examples for the priority services, apart from emergency services, further include calls initiated by departments or individuals related to national security, and calls initiated by a Very Important Person (VIP for short) user of the operator, etc.

Different countries have different requirements of the emergency services, for example emergency numbers, there are a plurality of the numbers, such as 110, 120, etc., in China, but there is only one emergency number, i.e., 911, in U.S.A.

When a user dials an emergency number, an Access Terminal (AT for short) firstly must recognize that the number dialed by the user is an emergency number, then informs the High Rate Packet Data (HRPD for short) Access Network (AN for short) (reference can be made to FIGS. 1 and 2 for the architecture of the HRPD AN) through an air interface about the situation that the user dials the emergency number, so as to make the HRPD AN take certain processes on the emergency call which are different from that on a common call, such as special resource assigning policy, special user authenticating process, and special charging rule, etc.

Refer to FIGS. 1 and 2, in the current HRPD air interface technology, the AT can already inform the AN through the air interface about the situation that whether a user is using an emergency service or not. However, in the current HRPD AN technology, since there is no any information used for indicating whether the user is utilizing an emergency service in the A9 signaling interface between the AN and the Packet Control Function (PCF for short) and the A11 signaling interface between a PCF and a Packet Data Serving Node (PDSN for short), the PCF and the PDSN can not recognize the emergence service and can not provide special process for it, which will result in that the HRPD AN element can not support emergency services.

### SUMMARY OF THE INVENTION

The present invention is provided aiming at the problem in the related art that the PCF and PDSN in an HRPD AN can not recognize emergency services. To this end, the object of the present invention is to provide an improved scheme for supporting emergency service on an HRPD AN to solve the above-mentioned problem in the related art.

For realizing above object, according to one aspect of the present invention, a method for supporting emergency service on an HRPD AN is provided.

The method for supporting emergency services on a HRPD AN according to the present invention comprises: an AN function entity sends information indicating whether a user is utilizing an emergency service to a PCF entity; the PCF entity forwards the information indicating whether a user is utilizing an emergency service to a PDSN.

Preferably, the AN function entity sends the information indicating whether a user is utilizing an emergency service to the PCF entity through an A9 signaling interface. The AN function entity sends the information indicating whether a user is utilizing an emergency service to the PCF entity by adding the information indicating whether a user is utilizing an emergency service into an A9-setup-A8 message or A9-update-A8 message.

Preferably, the PCF entity forwards the information indicating whether a user is utilizing an emergency service to the PDSN through an A11 signaling interface. The PCF entity sends the information indicating whether a user is utilizing an emergency service to the PDSN by adding the information indicating whether a user is utilizing an emergency service into an A11-registration request message.

Preferably, the AN function entity adds the information indicating whether a user is utilizing an emergency service into the A9-setup-A8 message or the A9-update-A8 message as an independent information unit. Preferably, the AN function entity adds the information indicating whether a user is utilizing an emergency service into an existing information unit of the A9-setup-A8 message or the A9-update-A8 message.

Preferably, the PCF entity adds the information indicating whether a user is utilizing an emergency service into the A11-registration request message as an independent information unit. Alternatively, the PCF entity adds the information indicating whether a user is utilizing an emergency service into the existing information unit of the A11-registration request message.

According to another aspect of the present invention, a PCF entity is provided.

The PCF entity according to the present invention comprises: a receiving module, configured to receive the information indicating whether a user is utilizing an emergency service from the network function entity; a forwarding module, configured to forward the information indicating whether a user is utilizing an emergency service received by the receiving module to a PDSN.

Preferably, the receiving module receives the information indicating whether a user is utilizing an emergency service through an A9 signaling interface; the forwarding module forwards the information indicating whether a user is utilizing an emergency service through an A11 signaling interface.

According to another aspect of the present invention, a system for supporting emergency service over an HRPD AN is provided.

The system for supporting emergency service according to the present invention comprises: an AN function entity including: a first receiving module, configured to receive information indicating whether a user is utilizing an emergency service from the user; a transmitting module, configured to transmit the information indicating whether a user is utilizing an emergency service received by the first receiving module; a PCF entity including: a second receiving module, configured to receive the information indicating whether a user is utilizing an emergency service from the transmitting module of the AN function entity; a forwarding module, configured to forward the information indicating whether a user is utilizing an emergency service received by the second receiving module; a PDSN including: a third receiving module, configured to receive the information indicating whether a user is utilizing an emergency service forwarded by the forwarding module of the PCF; a processing module, configured to process the information indicating whether a user is utilizing an emergency service received by the third receiving module.

By the present invention, the problem that emergency services can not be recognized by the PCF and PDSN in current HRPD AN can be solved through that the AN function entity sends the information indicating whether a user is utilizing an emergency service to the PCF, and that the PCF sends the information indicating whether a user is utilizing an emergency service to the PDSN, therefore, thus the support of emergent services over the HRPD AN can be realized.

It should be noted that, since the emergency service is one kind of priority service, the method for realizing that the HRPD AN supports emergency service mentioned in the present invention also can be applied to realize that the HRPD AN supports priority services. In particular, that is, above “the information indicating whether a user is utilizing an emergency service” can be expressed as “the information indicating whether a user is utilizing a priority service”.

Other features and advantages of the present invention will be detailed in the following description, and partly obvious from the description, or can be understood through implementing the present invention. The purposes and other advantages can be achieved and obtained through the structure specified by the specification, claims and drawings.

### BRIEF DESCRIPTION OF THE DRAWINGS

Drawings are provided herein for a further understanding of the present invention and form a part of the specification, schematic embodiments and explanations of themselves of the present invention are used to explain the present invention rather than limit the present invention. In the drawings:

FIG. 1 is the architecture of the HRPD AN according to related art, wherein the session control/mobility management function entity resides in the AN;

FIG. 2 is the architecture of the HRPD AN according to related art, wherein the session control/mobility management function entity resides in the PCF;

FIG. 3 is the flow chart of the method for supporting emergency service according to the embodiment of the present invention;

FIG. 4 is the schematic diagram of the flow of “Internet Protocol (IP for short) flow mapping update with service connection establishment” using the method of the present invention;

FIG. 5 is the schematic diagram of the flow of “the IP flow mapping update with an A8/A10 connection setup” using the method of the present invention; and

FIG. 6 is the schematic diagram of the information unit contained in the A9-setup-A8 message of HRPD AN technology A.S0008-C v1.0;

FIG. 7 is the block diagram of the structure of the PCF entity according to the device embodiment of the present invention;

FIG. 8 is the block diagram of the system for supporting emergency service according the system embodiment of the present invention.

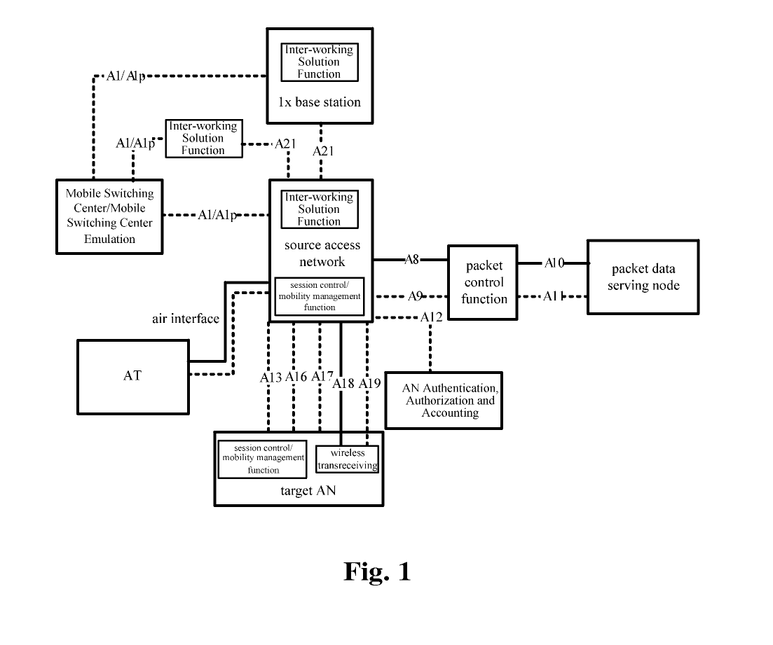

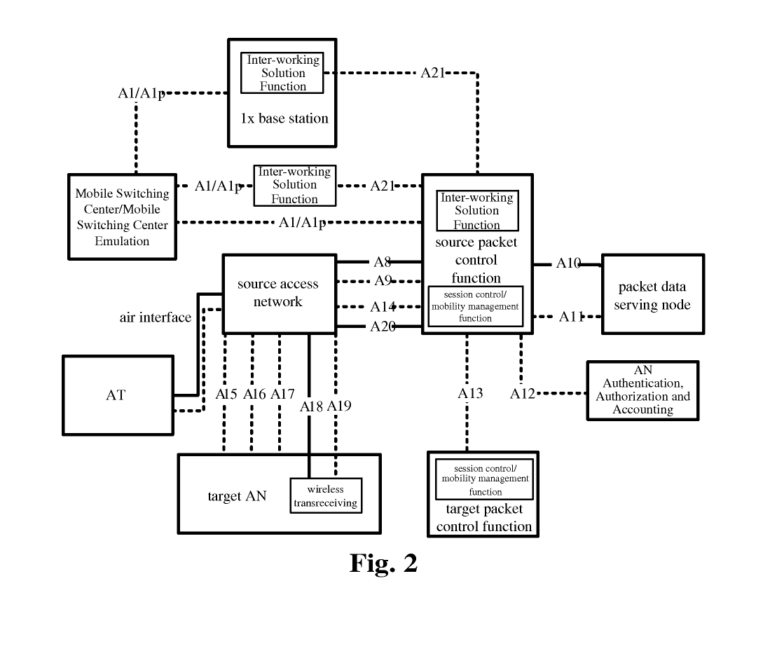

### DETAILED DESCRIPTION OF THE EMBODIMENTS

### Functionality Overview

Considering that the PCF and PDSN of an HRPD AN cannot recognize emergency services in the related art, the embodiments of the present invention provide a method and a system for supporting emergency services over an HRPD AN, and a PCF entity. In the embodiments of the present invention, through that the AN function entity sends the information indicating whether a user is utilizing an emergency service to the PCF, and that the PCF forwards the information indicating whether a user is utilizing an emergency service to the PDSN, the PCF and PDSN of the HRPD AN can be informed with the information indicating whether a user is utilizing an emergency service, thus, the support of emergent services by HRPD AN can be realized.

The particular embodiments of the present invention will be described in connection with the drawings. In case of no confliction, embodiments of the present invention and features thereof can be combined. It should be noted that, the steps illustrated in drawings can be implemented in a computer system of a set of instruction executable by a computer, moreover, the steps in the logic order illustrated in the flow charts can be performed in different orders in some circumstance.

### Method Embodiments

According to the embodiment of the present invention, a method for supporting emergency services over an HRPD AN is provided.

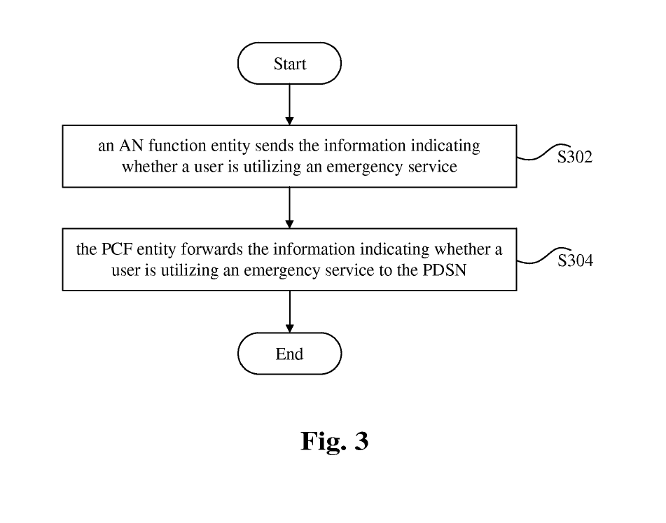

FIG. 3 is the flow chart of the method for supporting emergency service according to the embodiment of the present invention. As shown in FIG. 3, the method comprises the following steps (step S302 to step S304):
S302, an AN function entity sends information indicating whether a user is utilizing an emergency service to the PCF entity; preferably, the AN function entity may send the information through an A9 signaling interface;
In particular, the AN function entity sends the information indicating whether a user is utilizing an emergency service to the PCF entity by adding the information indicating whether a user is utilizing an emergency service into an A9-setup-A8 message or A9-update-A8 message; preferably, the AN function entity may also add the information indicating whether a user is utilizing an emergency service into the A9-setup-A8 message or the A9-update-A8 message as an independent information unit. Alternatively, the AN function entity adds the information indicating whether a user is utilizing an emergency service into an existing information unit of the A9-setup-A8 message or the A9-update-A8 message;
S304, the PCF entity forwards the information indicating whether a user is utilizing an emergency service to the PDSN; preferably, the PCF entity sends the information through an A11 signaling interface;
In particular, the PCF entity sends the information indicating whether a user is utilizing an emergency service to the PDSN by adding the information indicating whether a user is utilizing an emergency service into an A11-registration request message. Preferably, the PCF entity may also add the information indicating whether a user is utilizing an emergency service into the A11-registration request message as an independent information unit. Preferably, the PCF entity adds the information indicating whether a user is utilizing an emergency service into the existing information unit of the A11-registration request message.

FIG. 4 is the schematic diagram of the flow of “Internet Protocol (IP for short) flow mapping update with service connection establishment” using the method of the present invention. As shown in FIG. 4, the information indicating whether a user is utilizing an emergency service is added into the A9-setup-A8 message and the A11-registration request information, which enables the PCF and PDSN to perform corresponding process according to the information. In particular, as shown in FIG. 4, the flow comprises the following steps (step S402 to step S410):
S402, the AT and the AN perform session configuration for the IP flows and the AN maps a new IP flow or a re-activated IP flow to a new service connection;
S404, the AN sends an A9-Setup-A8 message to the PCF to establish the A8 connection and starts timer TA8-setup at the same time. The A9-Setup-A8 message includes the A8 Traffic ID for the main connection and Additional A8 Traffic IDs for auxiliary A8 connections. The negotiated Robust Header Compression (ROHC for short hereinafter) configuration parameters are also included if this message is establishing forward and/or reverse ROHC channels for PDSN-based ROHC on Service Option (SO for short hereinafter) 67. The A9-Setup-A8 message includes information on all A8 connections required for the new mapping, both those already established, and those to be established. A8 connections to be released are not included in the A9-Setup-A8 message. A9-Setup-A8 message also includes indicator indicating emergency service;
S406, the PCF sends an A11-Registration Request message to establish the A10 connection. The PCF starts timer Tregreq at the same time. The A11-Registration Request message includes the Session Specific Extension IE for the main connection and Additional Session Information for auxiliary connections in Normal Vendor Specific Extension (NVSE for short hereinafter). The negotiated ROHC configuration parameters are included if this message is establishing forward and/or reverse ROHC channels for PDSN-based ROHC on SO67. The PCF includes information on all A10 connections corresponding to A8 connections for which information was received in step ‘S304’;
S408, the PDSN adds the new A10 connection and sends an A11-Registration Reply message to the PCF. The PCF stops timer Tregreq. The A11-Registration Reply message includes the Session Specific Extension for the main connection and Additional Session Information in the NVSE for auxiliary connections. The PDSN includes information on all A10 connections for which information was received in step ‘S306’. The PDSN and PCF release the A10 connections for which information was not included in this message;
S410, the PCF adds the new A8 connection and sends an A9-Connect-A8 message to the AN. The AN stops timer TA8-setup. The A9-Connect-A8 message includes the A8 Traffic ID for the main connection and Additional A8 Traffic ID(s) for auxiliary connection(s). The A9-Connect-A8 message includes information on all A8 connections for which information was received in step ‘S402’. The PCF and AN release the A8 connections for which information is not included in this message.

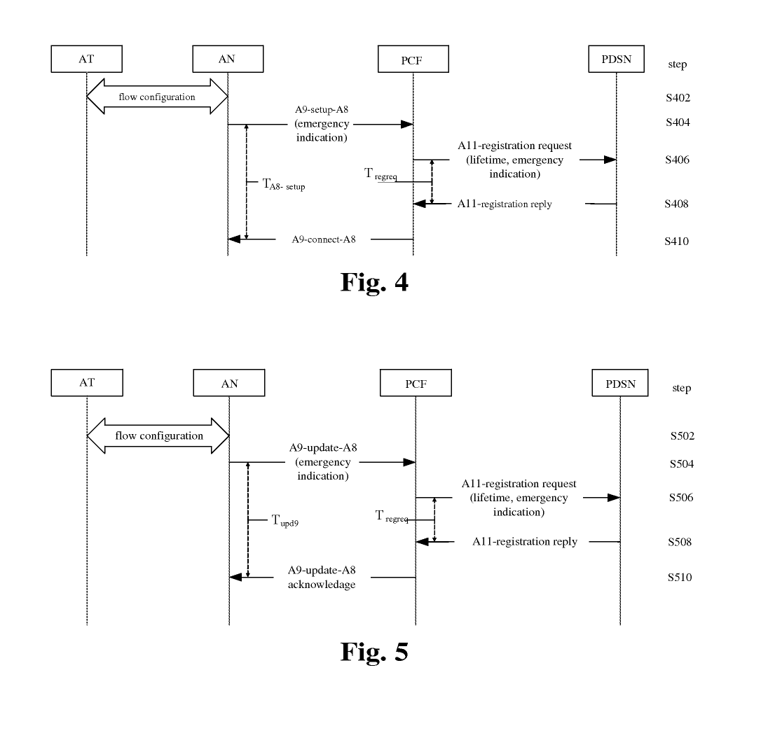

FIG. 5 is the schematic diagram of the flow of “IP flow mapping update with new A8/A10 connection setup” after using the method of the present invention. The process as shown in FIG. 5, the indication indicating whether the current connection is used for an emergency service is added into the A9-update-A8 message and the A11-registration request message, which enables the PCF and the PDSN to perform a corresponding process on the connection according to the information. In particular, as shown in FIG. 5, the process comprises the following steps (step S502 to step S510):
S502, the AT and the AN perform session configuration for the IP flows and the AN maps a new IP flow or a re-activated IP flow to a new service connection;
S504, the AN sends the A9-update-A8 message to the PCF to update the flow mapping information, and starts a timer Tupd9 at the same time. The A9-update-A8 message comprises the indication indicating whether a user is utilizing an emergency service;
S506, the PCF sends the A11-registration request message including flow mapping changes, with lifetime set to a non-zero value to the PDSN. The A11-Registration Request message includes information on all A10 connections corresponding to service connections for which information was received in S404. The PCF starts the timer Tregreq. The A11-registration request message also comprises the indication indicating whether a user is utilizing an emergency service;
S508, the PDSN sends an A11-registration reply message to the PCE. The A11-registration reply message comprises all A10 connections information received in S406. The PCF stops the timer Tregreq;
S510, the PCF sends an A9-update-A8 acknowledge message to the AN. The AN stops the timer Tupd9.

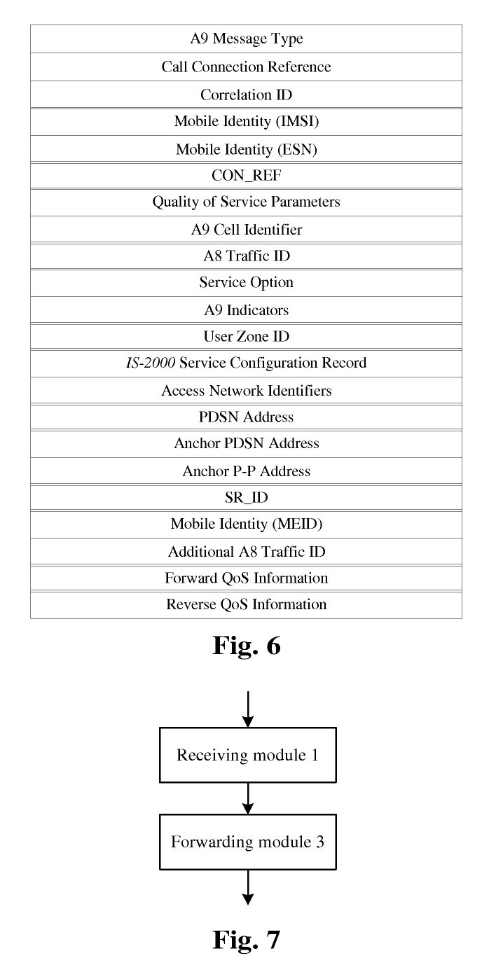

FIG. 6 is the information added to the A9-setup-A8 message for indicating whether a user is utilizing an emergency service, which can be realized by the following two methods (changes to the A9-update-A8 and the A11-registration request are similar to the A9-setup-A8): 1) defining a new information unit, and making the information unit comprise the information; 2) modifying the definition of current information unit, and making the information unit comprise the information.

Wherein, since method 2) relates to the change of the current information unit, which results in a greater influence caused by method 2) on the HRPD network than that caused by method 1).

For example, for method 1), a new information unit called as Emergency Indicator can be defined after the information unit of Reverse QoS Information. The Emergency Indicator information unit comprises a variable called as Emergency Service, which is used to indicate whether a user is utilizing an emergency service.

For method 2), a new variable called as Emergency Services may be added for each IP flow in current information unit of Forward QoS Information, which is used to indicate whether the IP flow is utilized for an emergency service. The method can realize the function of indicating whether a user is utilizing an emergency service, but since each IP flow is added with a new variable, more information is required to be added (compared with method 1).

### Device Embodiments

According to the embodiment of the present invention, a PCF entity is further provided.

FIG. 7 is the block diagram of the structure of the PCF entity according to the device embodiment of the present invention, as shown in FIG. 7, the PCF entity according to the present invention comprises:
a receiving module 1, configured to receive the information indicating whether a user is utilizing an emergency service from the AN function entity; preferably, the receiving module 1 receives the information through an A9 signaling interface, in particular, the receiving module 1 receives an A9-setup-A8 message or an A9-update-A8 message through an A9 signaling interface, and obtains the information from those messages.

A forwarding module 3, configured to forward the information indicating whether a user is utilizing an emergency service received by the receiving module 1 to the PDSN; preferably, the forwarding module 3 forwards the information through an A11 signaling interface, in particular, the forwarding module 3 adds the information to the A11-registration request message to forward to the PDSN.

By above mentioned receiving module and forwarding module, the information indicating whether a user is utilizing an emergency service, which is from the AN, can be forwarded to the PDSN, thus the support of emergency services over the HRPD AN can be realized.

### System Embodiments

According to the embodiment of the present invention, a system for supporting emergency service over an HRPD AN is provided.

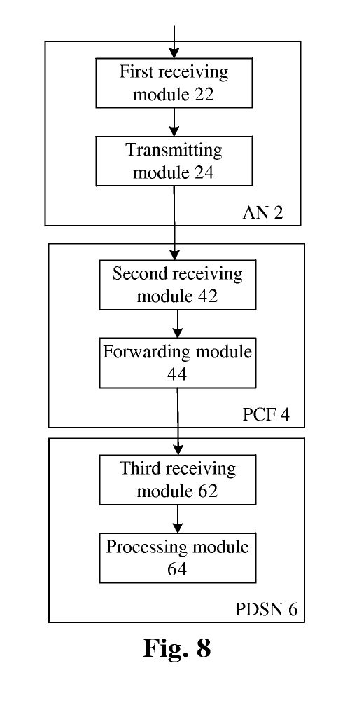

FIG. 8 is the block diagram of the system for supporting emergency service according the system embodiment of the present invention, as shown in FIG. 8, the system comprises: an AN 2, an PCF 4, an PDSN 6, whose functions will be detailed below.

The AN 2 is configured to send information indicating whether a user is utilizing an emergency service, which is from the user, to the PCF 4; in particular, the AN 2 comprises: a first receiving module 22 configured to receive the information indicating whether a user is utilizing an emergency service, which is from the user; a transmitting module 24, configured to send the information indicating whether a user is utilizing an emergency service received by the first receiving module 22, to the PCF 4. Preferably, the transmitting module 24 transmits the information through the A9 signaling interface, in particular, the transmitting module 24 transmits the A9-setup-A8 message or A9-update-A8 message through the A9 signaling interface.

The PCF 4 is configured to forward the information indicating whether a user is utilizing an emergency service, which is from the AN 2, to the PDSN 6. PCF 4 comprises a second receiving module 42 and a forwarding module 44 having similar function as that of the corresponding modules shown in FIG. 7, thus the description for them is omitted herein.

The PDSN 6 is configured to perform corresponding process according to the information indicating whether a user is utilizing an emergency service, which is from the PCF 4; in particular, the PDSN 6 comprises a third receiving module 62, configured to receive the information indicating whether a user is utilizing an emergency service, which is from the PCF 4; a processing module 64, configured to dispose the information indicating whether a user is utilizing an emergency service received by the third receiving module 62. Preferably, the third receiving module 62 receives the information through an A11 signaling interface, in particular, the third receiving module 62 receives the information through the A11-registration request message.

By above mentioned system, the information indicating whether a user is utilizing an emergency service, which is sent by a user, can be sent to the PCF through the AN, and then be forwarded to the PDSN by the PCF, thus the support of emergency services over the HRPD AN can be realized.

By the present invention, the problem that emergency services can not recognized by the PCF and PDSN in current HRPD AN may be solved, so, it makes the HRPD AN support emergency services.

It is to be noted that, since an emergency service is one kind of preferential service, the present invention method for realizing that the HRPD AN supports emergency services mentioned in the present invention also can be applied to realize that the HRPD AN supports priority services. In particular, that is, above “the information indicating whether a user is utilizing an emergency service” can be expressed as “the information indicating whether a user is utilizing a priority service”.

Obviously, those skilled in the art shall understand that individual modules and steps of the present invention can be implemented with general computation devices integrated together or distributed in the network formed by a plurality of computation devices, alternatively implemented with program codes executable by computation devices, which can be stored in memory devices for execution by the computation devices, or implemented with ICs, or several modules or steps can be implemented with a single IC. Thus, the present invention is not limited to any particular hardware and software combination.

Above description is to illustrate the preferred embodiments not limit the present invention. Various alterations and changes to the present invention are apparent to those skilled in the art. The scope defined in claims shall comprise any modification, equivalent substitution and improvement in the spirit and principle of the present invention.

1. A method for supporting emergency services over a High Rate Packet Data network, comprising:
an Access Network (AN) function entity sending information indicating whether a user is utilizing an emergency service to a Packet Control Function (PCF) entity;
the PCF entity forwarding the information indicating whether a user is utilizing an emergency service to a Packet Data Serving Node (PDSN).

2. The method for supporting emergency services according to claim 1, wherein the AN function entity sending the information indicating whether a user is utilizing an emergency service to the PCF entity through an A9 interface signaling.

3. The method for supporting emergency services according to claim 2, wherein the AN function entity sending the information indicating whether a user is utilizing an emergency service to the PCF entity by adding the information indicating whether a user is utilizing an emergency service into an A9-setup-A8 message or A9-update-A8 message.

4. The method for supporting emergency services according to claim 1, wherein the PCF entity forwarding the information indicating whether a user is utilizing an emergency service to the PDSN through an A11 interface signaling.

5. The method for supporting emergency services according to claim 4, wherein the PCF entity sending the information indicating whether a user is utilizing an emergency service to the PDSN by adding the information indicating whether a user is utilizing an emergency service into an A11-registration request message.

6. The method for supporting emergency services according to claim 3, wherein the AN function entity adding the information indicating whether a user is utilizing an emergency service into the A9-setup-A8 message or the A9-update-A8 message as an independent information unit.

7. The method for supporting emergency services according to claim 3, wherein the AN function entity adding the information indicating whether a user is utilizing an emergency service into an existing information unit of the A9-setup-A8 message or the A9-update-A8 message.

8. The method for supporting emergency services according to claim 5, wherein the PCF entity adding the information indicating whether a user is utilizing an emergency service into the A11-registration request message as an independent information unit.

9. The method for supporting emergency services according to claim 5, wherein the PCF entity adding the information indicating whether a user is utilizing an emergency service into the existing information unit of the A11-registration request message.

10. A Packet Control Function (PCF) entity, comprising:
a receiving module, configured to receive information indicating whether a user is utilizing an emergency service from an Access Network (AN) function entity;
a forwarding module, configured to forward the information indicating whether a user is utilizing an emergency service received by the receiving module to a Packet Data Serving Node (PDSN).

11. The PCF entity according to claim 10, wherein:
the receiving module receives the information indicating whether a user is utilizing an emergency service through an A9 interface signaling;
the forwarding module forwards the information indicating whether a user is utilizing an emergency service through an A11 interface signaling.

12. A system supporting emergency service over a High Rate Packet Data network, comprising:
an Access Network, (AN) function entity, including:
a first receiving module, configured to receive information indicating whether a user is utilizing an emergency service from the network function entity;
a transmitting module, configured to transmit the information indicating whether a user is utilizing an emergency service received by the first receiving module;
a Packet Control Function (PCF) entity, including:
a second receiving module, configured to receive the information indicating whether a user is utilizing an emergency service from the transmitting module of the AN function entity;
a forwarding module, configured to forward the information indicating whether a user is utilizing an emergency service received by the second receiving module;
a Packet Data Serving Node (PDSN) including:
a third receiving module, configured to receive the information indicating whether a user is utilizing an emergency service forwarded by the forwarding module of the PCF entity;
a processing module, configured to process the information indicating whether a user is utilizing an emergency service received by the third receiving module.

13. The method for supporting emergency services according to claim 2, wherein the PCF entity forwarding the information indicating whether a user is utilizing an emergency service to the PDSN through an A11 interface signaling.

14. The method for supporting emergency services according to claim 3, wherein the PCF entity forwarding the information indicating whether a user is utilizing an emergency service to the PDSN through an A11 interface signaling.

15. The method for supporting emergency services according to claim 13, wherein the PCF entity sending the information indicating whether a user is utilizing an emergency service to the PDSN by adding the information indicating whether a user is utilizing an emergency service into an A11-registration request message.

16. The method for supporting emergency services according to claim 14, wherein the PCF entity sending the information indicating whether a user is utilizing an emergency service to the PDSN by adding the information indicating whether a user is utilizing an emergency service into an A11-registration request message.

17. The method for supporting emergency services according to claim 15, wherein the PCF entity adding the information indicating whether a user is utilizing an emergency service into the A11-registration request message as an independent information unit.

18. The method for supporting emergency services according to claim 15, wherein the PCF entity adding the information indicating whether a user is utilizing an emergency service into the existing information unit of the A11-registration request message.

19. The method for supporting emergency services according to claim 16, wherein the PCF entity adding the information indicating whether a user is utilizing an emergency service into the A11-registration request message as an independent information unit.

20. The method for supporting emergency services according to claim 16, wherein the PCF entity adding the information indicating whether a user is utilizing an emergency service into the existing information unit of the A11-registration request message.
